(19) United States
(12) Patent Application Publication
(10) Pub. No.: US 2024/0044644 A1
(43) Pub. Date: Feb. 8, 2024

(54) LASER SQUARE WITH ADJUSTABLE TAB

(71) Applicant: TECHTRONIC CORDLESS GP, Anderson, SC (US)

(72) Inventor: Collin C. Burney, Greenville, SC (US)

(21) Appl. No.: 17/880,467

(22) Filed: Aug. 3, 2022

(51) Int. Cl. G01C 9/06

(52) U.S. Cl. CPC G01C 9/06; G01C 2009/066

(57) ABSTRACT

A laser square including a frame, a hub, and tabs. The frame has a first side and a second side. The hub extends from the first side and supports a laser level. The laser level is configured to project a laser. The tabs are adjustably coupled on the second side of the frame. Each of the tabs is independently rotatable between a first position and a second position to selectively align the frame with a corresponding edge of a workpiece.

### FIELD OF THE INVENTION

The present disclosure relates to leveling squares, and more specifically, leveling squares including laser levels.

### SUMMARY

In one aspect, the disclosure provides a laser square including a frame, a hub, and tabs. The frame has a first side and a second side. The hub extends from the first side and supports a laser level. The laser level is configured to project a laser. The tabs are adjustably coupled on the second side of the frame. Each of the tabs is independently rotatable between a first position and a second position to selectively align the frame with a corresponding edge of a workpiece.

In another aspect, the disclosure provides a laser square including a frame, a first tab, and a second tab. The frame includes a first edge and a second edge. The first tab is disposed adjacent the first edge. The first tab is rotatable between a first position and a second position to align the first edge with a first workpiece edge. The second tab is disposed adjacent the second edge. The second tab is rotatable between a third position and a fourth position to align the second edge with a second workpiece edge.

In yet another aspect, the disclosure provides a laser square including a frame, a hub, and plurality of tabs. The frame includes a plurality of edges and a plurality of measuring scales. Each measuring scale is disposed on a corresponding edge. The hub extends from the frame. The hub includes a plurality of vial levels and a plurality of laser levels. The plurality of tabs is disposed on a side of the frame opposite from the laser levels. The tabs are independently rotatable relative to the frame.

### BRIEF DESCRIPTION OF THE DRAWINGS

FIG. 1 is a perspective view of a laser square according to an embodiment of the disclosure.

FIG. 2 is a top view of the laser square of FIG. 1.

FIG. 3 is a bottom view of the laser square of FIG. 1.

FIG. 4A is a front view of the laser square of FIG. 1.

FIG. 4B is a front view of the laser square of FIG. 1.

FIG. 5A is a section view taken along a first edge of the laser square of FIG. 1.

FIG. 5B is a section view taken along a second edge of the laser square of FIG. 1.

FIG. 6A is an enhanced perspective view of a tab for the laser square of FIG. 1 in a first position.

FIG. 6B is an enhanced perspective view of the tab of FIG. 5A in a second position.

FIG. 7 is a perspective view of the laser square of FIG. 1 aligned along a workpiece.

### DETAILED DESCRIPTION OF THE DRAWINGS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

The detailed description uses numerical and letter designations to refer to features in the drawings. Like or similar designations in the drawings and description have been used to refer to like or similar parts of the invention.

The singular forms “a,” “an,” and “the” include plural references unless the context clearly dictates otherwise. The terms “coupled,” “fixed,” and the like refer to both direct coupling or fixing, as well as indirect coupling or fixing through one or more intermediate components or features, unless otherwise specified herein. As used herein, the terms “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

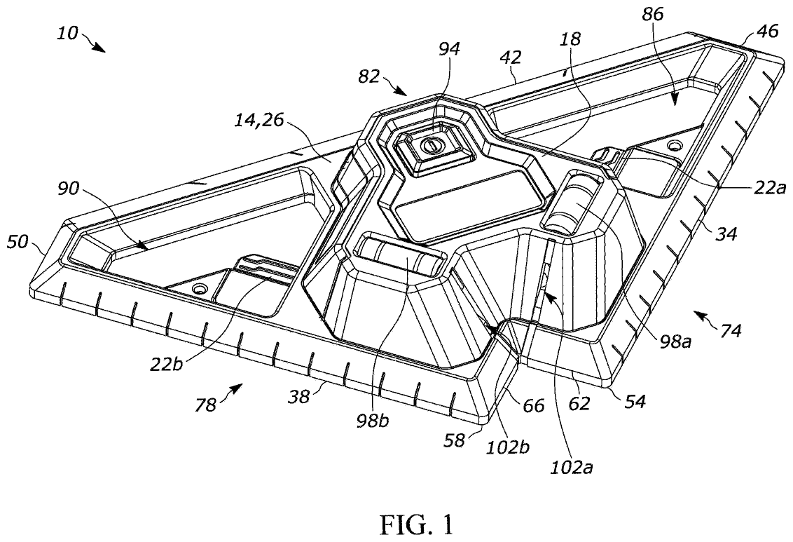

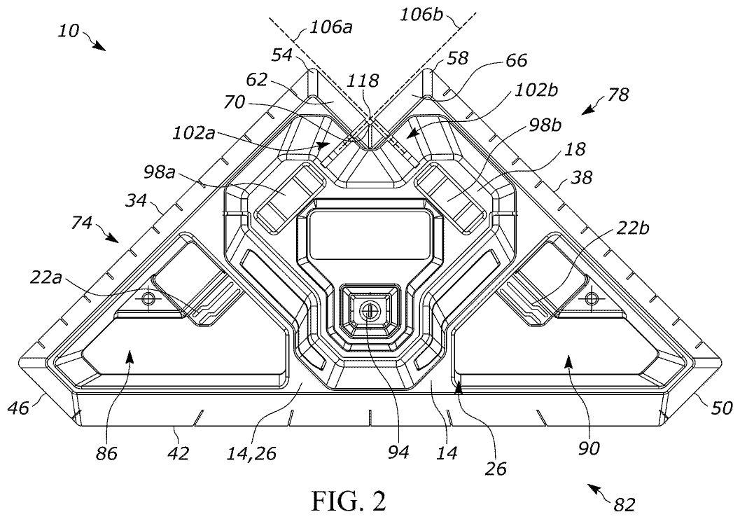

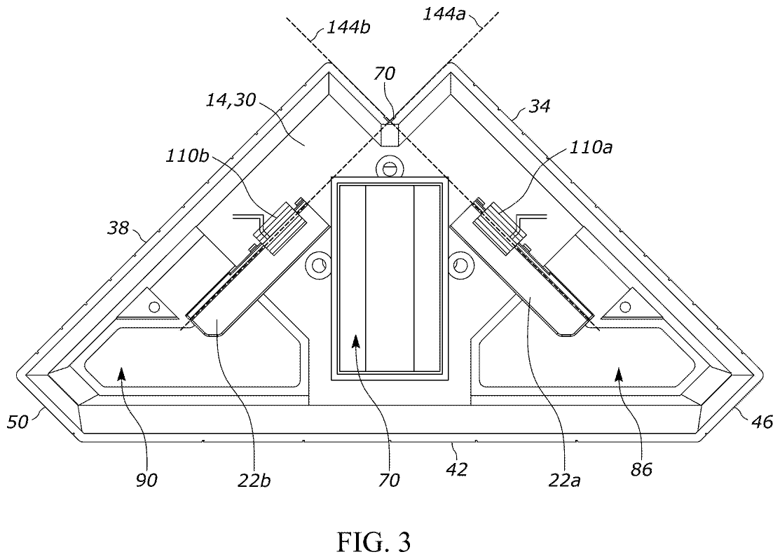

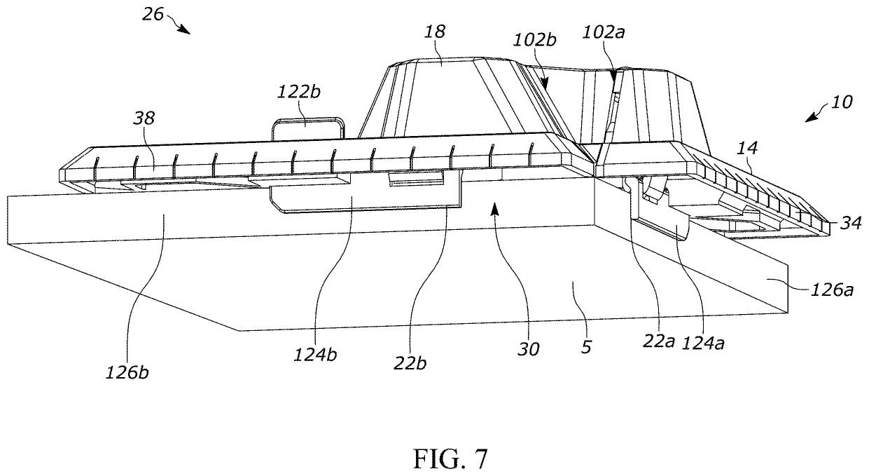

FIG. 1 illustrates an exemplary laser square 10 that may be used, among other applications, to accurately level workpieces 5 (e.g., as illustrated in FIG. 7) or to provide a level reference between multiple workpieces 5. The laser square 10 includes a frame 14, a hub 18, and tabs 22a, 22b. The frame 14 includes a first side 26 (FIG. 2), a second side 30 (FIG. 3), a first edge 34, a second edge 38, and a third edge 42. In use, the first side 26 is a top side or a user-engagement side and the second side 30 is a bottom side or a workpiece-engagement side. With reference to FIG. 3, the second side 30 includes a battery receptacle 32 to receive a battery to power the hub 18.

As best illustrated in FIG. 2, the first edge 34, the second edge 38, and the third edge 42 define a substantially triangular shape of the frame 14. The first edge 34 and the second edge 38 form legs of a triangle and the third edge 42 forms the hypotenuse. The frame 14 further includes a first transition edge 46 and a second transition edge 50. The first transition edge 46 extends from the third edge 42 to the first edge 34 at an obtuse angle relative to the third edge 42. The second transition edge 50 extends from the third edge 42 to the second edge 38 at an obtuse angle relative to the third edge 42. The first edge 34 extends from the first transition edge 46 to a first edge peak 54. The second edge 38 extends from the third edge 42 to a second edge peak 58. The frame 14 additionally includes a first inward edge 62 and a second inward edge 66. The first inward edge 62 extends from the first edge peak 54 to a first intersection point 70. The second inward edge 66 extends from the second edge peak 58 to the first intersection point 70 such that the first inward edge 62 and the second inward edge 66 intersect at the first intersection point 70.

The first edge 34 includes a first measuring scale 74, the second edge 38 includes a second measuring scale 78, and the third edge 42 includes a third measuring scale 82. As shown, the first measuring scale 74 and the second measuring scale 78 have the same linear measuring units and markers for the measuring units. The third measuring scale 82 defines angular measuring units. In some embodiments, the first measuring scale 74, the second measuring scale 78, and the third measuring scale 82 may all be substantially the same. In other embodiments, the first measuring scale 74, the second measuring scale 78, and the third measuring scale 82 may all be different.

The frame 14 further includes a first aperture 86 and a second aperture 90. The first aperture 86 is defined between the first edge 34, the first transition edge 46, the third edge 42, and the hub 18. The second aperture 90 is defined between the second edge 38, the second transition edge 50, the third edge 42, and the hub 18. Each of the first aperture 86 and the second aperture 90 extend through the first side 26 and the second side 30 of the frame 14.

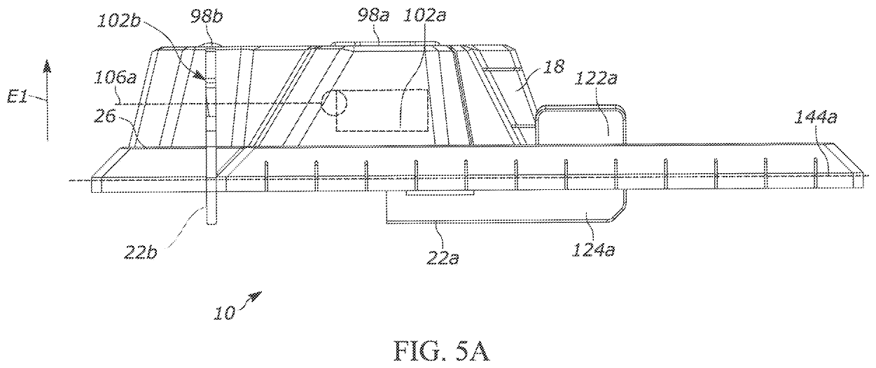

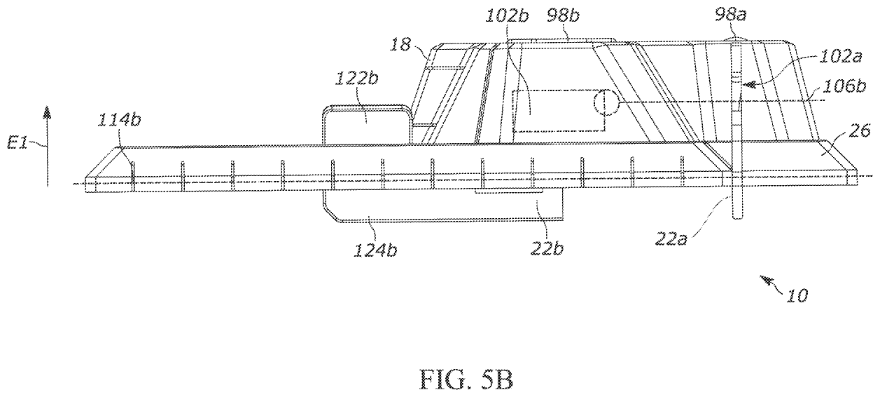

With continued reference to FIG. 2, the hub 18 extends from the first side 26 of the frame 14 along an extension direction E1, as illustrated in FIG. 5A, between the first edge 34, the second edge 38, and the third edge 42. The hub 18 is centrally located on the frame 14 and has a substantially Y-shaped cross-section. The hub 18 includes an actuator 94, first and second vial levels 98a, 98b, and first and second laser levels 102a, 102b. The actuator 94 is positioned adjacent to the third edge 42 of the frame 14, although the actuator may be otherwise located. The actuator 94 is operable to selectively turn the laser levels 102a, 102b on and off. The first vial level 98a and the first laser level are positioned adjacent the first edge 34, and the second vial level 98b and the second laser level 102b are positioned adjacent the second edge 38. As best illustrated in FIGS. 5A and 5B, the first vial level 98a extends substantially parallel to the first edge 34 of the frame 14 (e.g., FIG. 2), and the second vial level 98b extends substantially parallel to the second edge 38 of the frame 14 (e.g., FIG. 2). The first laser level 102a is disposed in the hub 18 between the first vial level 98a and the first side 26 of the frame 14. The second laser level 102b is disposed in the hub 18 between the second vial level 98b and the first side 26 of the frame 14. When the laser square 10 is turned on (i.e. when the actuator 94 illustrated in FIG. 2 is pressed as appropriate to turn on the laser levels 102a, 102b), the first laser level 102a projects a first laser 106a along an extension direction of the first vial level 98a, and the second laser level 102b projects a second laser 106b along an extension direction of the second vial level 98b. As such, as illustrated in FIG. 2, the first laser 106a extends substantially parallel to the first edge 34 and the second laser 106b extends substantially parallel to the second edge 38. As shown, the second laser 106b extends in a direction that is transverse to the first laser 106a.

As illustrated in FIG. 3, the tabs 22a, 22b are rotatably or pivotably coupled to the frame 14 from adjacent the second side 30 of the laser square 10. As shown, the first tab 22a extends substantially parallel or parallel to the first edge 34 and is rotatably coupled to the second side 30 of the frame 14 at a first pivot joint 110a such that the first tab 22a moves relative to the frame 14 between a use or engagement position and a stored position. The second tab 22b extends substantially parallel or parallel to the second edge 38 and is rotatably coupled to the second side 30 of the frame 14 at a second pivot joint 110b such that the second tab 22b moves relative to the frame 14 between a use or engagement position and a stored position. It should be appreciated that each of the first tab 22a and the second tab 22b are separately manipulatable such that each tab 22a, 22b may be varied between the stored position and the use position independent of the other tab 22a, 22b. The first pivot joint 110a and the first tab 22a are aligned with the first vial level 98a and the first laser level 102a along the extension direction E1 of the hub 18 (FIG. 5A). The second pivot joint 110b and the second tab 22b are aligned with the second vial level 98b and the second laser level 102b along the extension direction E1 of the hub 18 (FIG. 5B).

With continued reference to FIG. 3, the first tab 22a extends along a first axis 114a that is aligned with the first pivot joint 110a and the second tab 22b extends along a second axis 114b that is aligned with the second pivot joint 110b. The second axis 114b intersects the first axis 114a at the first intersection point 70 between the first inward edge 62 and the second inward edge 66 (e.g., FIG. 2). As best illustrated in FIG. 5A, the first axis 114a extends parallel to the first laser 106a. As best illustrated in FIG. 5B, the second axis 114b extends parallel to the second laser 106b. With reference to FIGS. 2 and 3, the first laser 106a and the second laser 106b intersect at a second intersection point 118 that is different from the first intersection point 70. The second intersection point 118 is adjacent to, but offset from, the first intersection point 70 between the first axis 114a and the second axis 114b. As shown, the second intersection point 118 is located in front of the intersection point 70 (e.g., the second intersection point 118 is located on a side the intersection point 70 that is opposite the third edge 42).

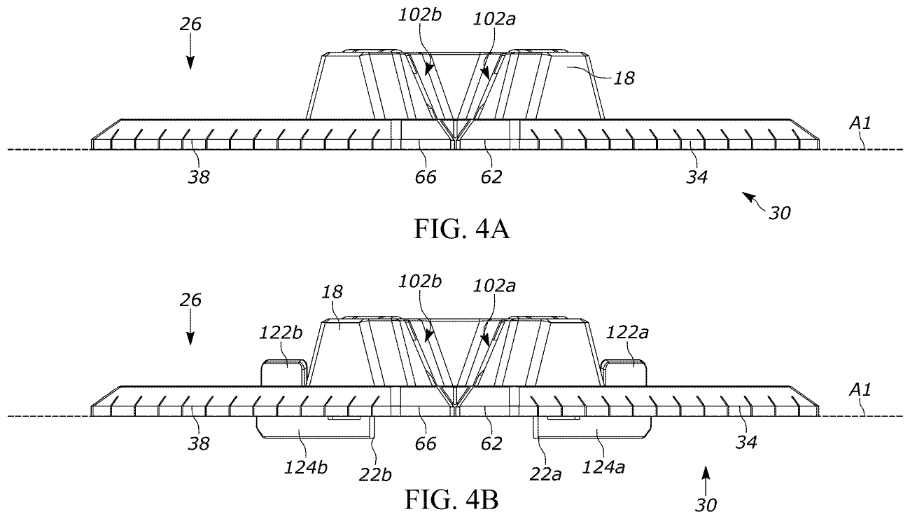

With reference to FIGS. 4A and 4B, the first tab 22a is rotatable between a first position (e.g., the stored position; FIG. 4A) and a second position (e.g., the use position; FIG. 4B). In the first position, the first tab 22a is disposed substantially parallel to a plane A1 that is defined by the second side 30 of the frame 14. More specifically, the plane A1 is defined by the second side 30 of the frame 14 along the first edge 34, the second edge 38, and the third edge 42. The first tab 22a is recessed from the plane A1 in the first position such that when the laser square 10 engages a workpiece with the first tab 22a in the first position, the first tab 22a does not engage the workpiece. As such, the first position may also be considered or referred to as the stored position. In the second position, the first tab 22a extends perpendicular to the plane A1 that is defined by the second side 30 of the frame 14 and may engage a workpiece. As such, the second position may be considered or referred to as an alignment or use position. In the second position, an arm portion 122a of the first tab 22a extends through the first aperture 86 while a main body portion 124a of the first tab 22a extends through the plane A1. With reference to FIG. 5A, in the first position and the second position, the first axis 114a of the first tab 22a extends parallel to an extension direction of the first vial level 98a and the first laser 106a.

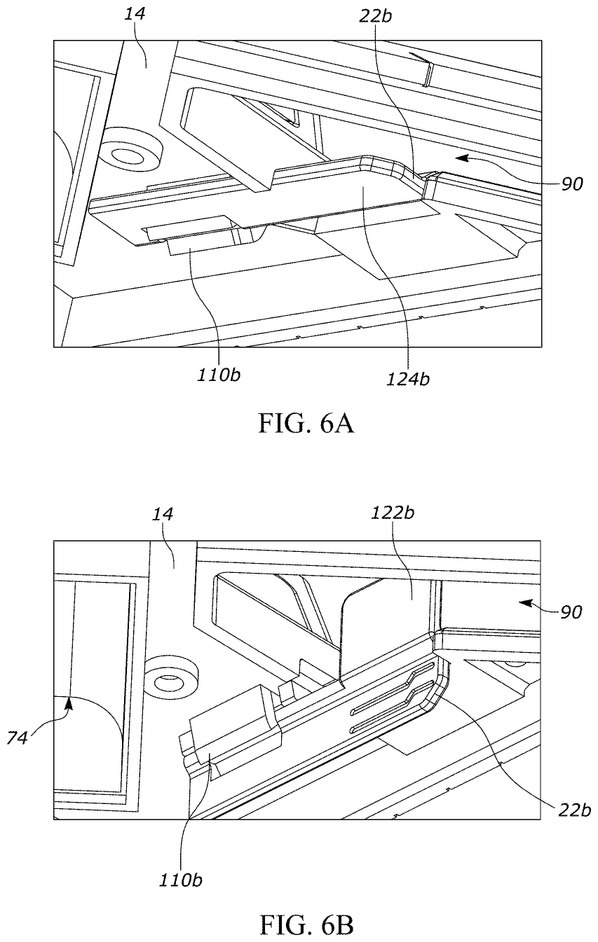

The second tab 22b is rotatable between a third position (e.g., the stored position; FIG. 4A) and a fourth position (e.g., the use position; FIGS. 4B and 6B). In the third position, the second tab 22b is disposed substantially parallel to the plane A1. Additionally, the second tab 22b is recessed from the plane A1 in the third position such that when the laser square 10 engages a workpiece with the second tab 22b in the third position, the second tab 22b does not engage the workpiece. As such, the third position may also be considered or referred to as a stored position. In the fourth position, the second tab 22b extends perpendicular to the plane A1 and may engage a workpiece. As such, the fourth position may also be considered or referred to as an alignment or use position. In the fourth position, an arm portion 122b of the second tab 22b extends through the second aperture 90 while a main body portion 124b of the second tab 22b extends through the plane A1. With reference to FIG. 5B, in the third position and the fourth position, the second axis 114b of the second tab 22b extends parallel to an extension direction of the second vial level 98b and the second laser 106b.

In operation, a user may rotate the first tab 22a from the first position to the second position and/or rotate the second tab 22b from the third position to the fourth position (together with the first tab 22a or separate from the first tab 22a) to align the frame 14 with a workpiece. The first aperture 86 enables a user to move the first tab 22a between the first position and the second position from the first side 26 or the second side 30, and the second aperture 90 enables a user to move the second tab 22b between the third position and the fourth position from the first side 26 and the second side 30. In other words, a user may manipulate the first tab 22a and the second tab 22b from the first side 26 and the second side 30 of the frame 14. With reference to FIG. 7, with either or both of the first tab 22a and the second tab 22b in the second position and the fourth position, respectively, a user may place the second side 30 of the frame 14 of the laser square 10 on the workpiece 5 such that the tab 22 that is in the second or fourth position engages an edge of the workpiece 5. Each of the first tab 22a and the second tab 22b is oriented and manipulatable to engage an edge of the workpiece 5. The first tab 22a may engage one edge 126a of the workpiece 5 to align the first laser 106a (e.g., as illustrated in FIG. 2) with the edge 126a of the workpiece 5. The second tab 22b may engage another edge 126b of the workpiece 5 to align the second laser 106b (e.g., as illustrated in FIG. 2) with the edge 126b of the workpiece 5. The tabs 22a, 22b may be used to align the laser square 10 along a single edge of a workpiece or separate edges of a workpiece (e.g., adjacent a corner of the workpiece).

Although the disclosure has been described in detail with reference to certain preferred embodiments, variations and modifications exist within the scope and spirit of one or more independent aspects of the disclosure as described.

1. A laser square comprising:
a frame including a first side and a second side;
a hub extending from the first side and supporting a laser level, the laser level configured to project a laser;
tabs adjustably coupled on the second side of the frame, each of the tabs independently rotatable between a first position and a second position to selectively align the frame with a corresponding edge of a workpiece.

2. The laser square of claim 1, wherein the tabs includes a first tab that extends along a first axis and a second tab that extends along a second axis, and wherein the second axis is transverse to the first axis.

3. The laser square of claim 2, wherein the laser level is a first laser level that projects a first laser, and wherein the laser square further including a second laser level supported by the hub and configured to project a second laser extending transverse to the first laser.

4. The laser square of claim 3, wherein the first axis is parallel to the first laser and the second axis is parallel to the second laser.

5. The laser square of claim 1, wherein the frame includes at least one aperture and wherein the tab is rotatable between the first position and the second position from the first side and the second side of the laser square.

6. The laser square of claim 5, wherein a portion of the tab extends through the aperture and is accessible from the first side of the frame when the tab is in the second position.

7. The laser square of claim 1, further comprising a battery receptacle positioned on the second side of the frame.

8. The laser square of claim 1, wherein the frame includes a pivot joint on the second side of the frame and the tab is rotatably coupled to the pivot joint.

9. The laser square of claim 1, wherein the second side of the frame defines a plane, and wherein the tabs are oriented substantially parallel to the plane in the first position and the tabs are oriented substantially perpendicular to the plane in the second position.

10. The laser square of claim 10, wherein each of the tabs is recessed within the frame in the first position such that each of the tabs does not to engage the workpiece.

11. A laser square comprising:
a frame including a first edge and a second edge;
a first tab disposed adjacent the first edge, the first tab movable between a first position and a second position to selectively align the first edge with a first workpiece edge; and
a second tab disposed adjacent the second edge, the second tab movable between a third position and a fourth position to selectively align the second edge with a second workpiece edge.

12. The laser square of claim 11, wherein the frame further includes a third edge such that the frame is defined by a substantially triangular shape by the first edge, the second edge, and the third edge.

13. The laser square of claim 11, wherein the first tab extends substantially parallel to the first edge, and the second tab extends substantially parallel to the second edge.

14. The laser square of claim 12, wherein the first tab extends along a first axis and the second tab extends along a second axis, wherein the first axis and the second axis intersect at a first point of intersection, and wherein the first axis extends parallel to a first laser generated by the first laser level and the second axis extends parallel to a second laser generated by the second laser level.

15. The laser square of claim 1, wherein each of the first tab and the second tab are separately movable to the second position and the fourth position, respectively.

16. The laser square of claim 14, wherein the first laser and the second laser intersect at a different point than the point of intersection between the first axis and the second axis.

17. A laser square comprising:
a frame including a plurality of edges and a plurality of measuring scales, each measuring scale disposed on a corresponding edge;
a hub extending from the frame, the hub including
a plurality of vial levels, and
a plurality of laser levels;
a plurality of tabs disposed on a side of the frame opposite the hub,
wherein the tabs are independently rotatable relative to the frame.

18. The laser square of claim 17, wherein the plurality of edges includes a first edge, a second edge, and a third edge, and wherein the plurality of measuring scales includes a first measuring scale disposed on the first edge, a second measuring scale disposed on the second edge, and a third measuring scale disposed on the third edge.

19. The laser square of claim 18, wherein the first measuring scale and the second measuring scale count by the same measuring units, and wherein the third measuring scale counts by measuring units that are different from the measuring units of the first measuring scale and the second measuring scale.

20. The laser square of claim 19, wherein the plurality of vial levels includes a first vial level and a second vial level, wherein the plurality of laser levels includes a first laser level and a second laser level, wherein the plurality of tabs includes a first tab and a second tab, wherein the first tab is configured to align the first laser level and the first vial level relative to a first edge of a workpiece, and wherein the second tab is configured to align the second laser level and the second vial level relative to a second edge of the workpiece.
